(19) United States
(12) Patent Application Publication
(10) Pub. No.: US 2025/0190271 A1
(43) Pub. Date: Jun. 12, 2025

(54) KUBERNETES-BASED PARTITIONED COMPUTING METHOD AND APPARATUS CONSIDERING GPU TASK SCHEDULING

(71) Applicant: FOUNDATION OF SOONGSIL UNIVERSITY-INDUSTRY COOPERATION, Seoul (KR)

(72) Inventors: Young Han KIM, Seoul (KR); In Gi LEE, Seoul (KR)

(73) Assignee: FOUNDATION OF SOONGSIL UNIVERSITY-INDUSTRY COOPERATION, Seoul (KR)

(21) Appl. No.: 18/952,538

(22) Filed: Nov. 19, 2024

(30) Foreign Application Priority Data
Dec. 11, 2023 (KR) 10-2023-0178903

(51) Int. Cl. G06F 9/50

(52) U.S. Cl. CPC G06F 9/5061

(57) ABSTRACT

A Kubernetes-based partitioned computing apparatus considering GPU task scheduling includes a first custom controller that generate a second custom resource corresponding to a plurality of terminals by referencing a first custom resource that defines an optimal partitioned point determination algorithm of a head model executed on a terminal side and a tail model executed on a server side of a deep neural network model to be applied to the plurality of terminals; and a second custom controller that determines a partitioned point of each of the plurality of terminals by referencing the second custom resource and determines GPU scheduling on the server side for a tail model selected according to the determined partitioned point.

### CROSS-REFERENCE TO RELATED APPLICATION

This application claims the benefit of priority under 35 U.S.C. § 119 (a) to Korean Patent Application No. 10-2023-0178903 filed on Dec. 11, 2023, the entire contents of which are incorporated herein by reference.

### BACKGROUND

### (a) Technical Field

The present disclosure relates to a Kubernetes-based partitioned computing method and apparatus considering GPU (graphics processing unit) task scheduling.

### (b) Background Art

Partitioned computing is being studied as a distributed computing method that can efficiently execute a complex deep neural network (DNN) model by jointly using a terminal and server with a limited resource.

By determining an optimal partitioned point, executing a part of the DNN model (head model) on the terminal, then sending an intermediate result to the server, and then deriving a final inference result from a tail model, a computation time can be minimized from the existing local inference method on the terminal with the limited resource, and the overall inference speed can be improved.

However, due to the characteristics of various heterogeneous terminals, it is difficult to implement and manage partitioned computing on various terminals, and this difficulty can increase as the number of terminals increases. As the number of heterogeneous terminals increases, the characteristics, versions, update status, and errors of respective terminals should be manually tracked and managed, and the algorithm should be modified and optimized for each different environment, which increases the probability of errors and may increase the management burden.

In addition, as the number of terminals increases, the load on the server or central computing device increases, and in general environments, efficient resource management may be difficult due to the lack of an automatic expansion function. Accordingly, as the number of terminals increases, efficient and fair distribution of GPU resources to be used by tail models operating on servers is required, and a method for reducing the complexity of management and operation of the existing partitioned computing should be presented.

### PRIOR ART DOCUMENT

### Patent Document

KR Patent No. 10-2488614

### SUMMARY OF THE DISCLOSURE

To solve the problems of the above-mentioned related art, the present disclosure assumes an environment in which multiple heterogeneous terminals are combined with a single Kubernetes cluster including multiple servers to utilize partitioned computing, and proposes a Kubernetes-based partitioned computing system considering GPU task scheduling that can resolve the complexity of management and operation of the existing partitioned computing by utilizing a Kubernetes operator.

In order to achieve the above object, according to an aspect of the present disclosure, there is provided a Kubernetes-based partitioned computing apparatus considering GPU task scheduling, the partitioned computing apparatus including: a first custom controller that generate a second custom resource corresponding to a plurality of terminals by referencing a first custom resource that defines an optimal partitioned point determination algorithm of a head model executed on a terminal side and a tail model executed on a server side of a deep neural network model to be applied to the plurality of terminals; and a second custom controller that determines a partitioned point of each of the plurality of terminals by referencing the second custom resource and determines GPU scheduling on the server side for a tail model selected according to the determined partitioned point.

The first custom resource may be a DeviceConfiguration custom resource, and the second custom resource may be a PartitionDecision custom resource.

The first custom controller may access the plurality of terminals and collect at least one of an ID of each terminal, channel information storing an event generated from each terminal, an optimal partitioned point determination algorithm to be used by each terminal, and a resource metric of each terminal to generate the second custom resource.

The second custom resource may be dependent on the first custom resource.

The second custom controller may calculate a GPU resource requirement for the tail model corresponding to each of the plurality of terminals using an available resource and GPU information according to the partitioned point determined for each of the plurality of terminals, and determine a scheduling order using the calculated GPU resource requirements and tail model identification information before GPU virtualization.

The second custom controller may virtualize a GPU according to the calculated GPU resource requirement and allocate the tail model corresponding to each of the plurality of terminals to the virtualized GPU.

When priorities are the same, the second custom controller may combine bin packing and shortest job first (SJF) methods so that a priority of a task whose order is reversed is adjusted upward when a first in first out (FIFO) principle is violated by the SJF.

The second custom controller may generate an InferenceGraph between a terminal-side head model and a server-side tail model when GPU allocation to a tail model corresponding to each of the plurality of terminals is completed.

The second custom controller may reflect endpoint information of the InferenceGraph to a Subscription that receives an event from the channel so that inference is performed.

According to another aspect of the present disclosure, there is provided a Kubernetes-based partitioned computing apparatus considering GPU task scheduling, the partitioned computing apparatus including: a plurality of terminals; and a Kubernetes-based cluster that is connected to the plurality of terminals through a network, generates a second custom resource corresponding to the plurality of terminals by referencing a first custom resource that defines an optimal partitioned point determination algorithm of a head model executed on a terminal side and a tail model executed on a server side of a deep neural network model to be applied to the plurality of terminals, determines a partitioned point of each of the plurality of terminals by referencing the second custom resource, and determines GPU scheduling on the server side for a tail model selected according to the determined partitioned point.

According to still another aspect of the present disclosure, there is provided a Kubernetes-based partitioned computing method considering GPU task scheduling, the partitioned computing method including: generating a second custom resource corresponding to a plurality of terminals by referencing a first custom resource that defines an optimal partitioned point determination algorithm of a head model executed on a terminal side and a tail model executed on a server side of a deep neural network model to be applied to the plurality of terminals; and determining a partitioned point of each of the plurality of terminals by referencing the second custom resource and determining GPU scheduling on the server side for a tail model selected according to the determined partitioned point.

According to the present disclosure, by providing a management and operation system for partitioned computing in a Kubernetes cluster in which heterogeneous terminals and servers are integrated, management complexity and fairness issues in resource distribution due to an increase in the number of terminals can be solved.

In addition, according to the present disclosure, by enabling automated lifecycle management and selection of algorithms that meet conditions through newly defined custom resources and controllers, it is possible to flexibly respond to the diversity and dynamic changes of terminals.

In addition, the proposed GPU task scheduling method efficiently and fairly allocates resources required by each terminal, so that the average task waiting time for the tail model decreases as the task processing speed increases, thereby reducing a delay time of the entire inference task.

### BRIEF DESCRIPTION OF DRAWINGS

FIG. 1 is a diagram illustrating a Kubernetes-based partitioned computing system according to a preferred embodiment of the present disclosure.

FIG. 2 is a diagram illustrating a detailed configuration of a partitioned computing environment according to the present embodiment.

FIG. 3 is a diagram illustrating the execution process of a second custom controller according to the present embodiment.

FIGS. 4A to 4C are diagrams illustrating an example of a GPU task scheduling method according to the present embodiment.

### DETAILED DESCRIPTION

The present disclosure can be modified in various ways and can have various embodiments, and specific embodiments are illustrated in the drawings and described in detail in the detailed description. However, this is not intended to limit the present disclosure to specific embodiments, and should be understood to include all modifications, equivalents, or substitutes included in the spirit and technical scope of the present disclosure.

The terms used in the present specification are used only to describe specific embodiments, and are not intended to limit the present disclosure. The singular expression includes the plural expression unless the context clearly indicates otherwise. In the present specification, the term “include” or “have” is intended to specify the presence of features, numerals, steps, operations, components, parts, or combinations thereof described in the specification, and it should be understood not to exclude the presence or the possibility of addition of one or more other features, numerals, steps, operations, components, parts, or combinations thereof in advance.

In addition, the components of the embodiment described with reference to each drawing are not limitedly applied only to the corresponding embodiment, and may be implemented to be included in other embodiments within the scope of maintaining the technical idea of the present disclosure, and further, even if a separate description is omitted, it is natural that a plurality of embodiments may be re-implemented as one embodiment.

In addition, in the description with reference to the accompanying drawings, regardless of reference numerals, the same components will be given the same or related reference numerals and duplicate description thereof will be omitted. When it is decided that the detailed description of the known art related to the present disclosure may unnecessarily obscure the gist of the present disclosure, a detailed description therefor will be omitted.

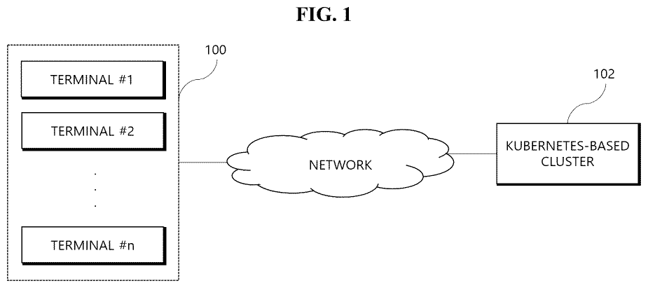

FIG. 1 is a diagram illustrating a Kubernetes-based partitioned computing system according to a preferred embodiment of the present disclosure.

The partitioned computing system according to the present embodiment in FIG. 1 may include a plurality of terminals 100 and a Kubernetes-based cluster 102 connected to the plurality of terminals 100 through a network.

The plurality of terminals 100 are terminals that can communicate with the server through a network and can perform an inference process using a deep neural network (DNN) model, and may include heterogeneous terminals such as smart watches and various home IoT devices in addition to conventional smartphones.

In the present embodiment, the plurality of terminals 100 are defined as terminals that execute a head model, which is part of the DNN model, for partitioned computing.

The network connecting the plurality of terminals 100 and a Kubernetes-based cluster 102 can include wired and wireless Internet networks and mobile communication networks.

A Kubernetes-based cluster 102 is a cluster that includes one or more servers that execute a tail model of the deep neural network model.

According to the present embodiment, an environment is assumed in which multiple heterogeneous terminals are combined with a single Kubernetes-based cluster including multiple servers to utilize partitioned computing, and the complexity of management and operation of the existing partitioned computing is resolved by utilizing a Kubernetes operator.

In the existing partitioned computing environment, multiple terminals operate with one server or multiple servers. Due to the nature of an edge environment, the number of terminals will be much greater than the number of servers, but there is no way to manage the life cycle of numerous terminals in the existing partitioned computing environment.

That is, there is no way to automatically manage and distribute the necessary software when a terminal connected to a server is newly added or removed for partitioned computing, so the environment settings should be individually set for each newly added or removed terminal.

Therefore, the present embodiment proposes a Kubernetes operator necessary for using partitioned computing in a Kubernetes environment, and tries to resolve the complexity of existing partitioned computing in terms of management and operation by utilizing a declarative API method.

In addition, for the tail model on the server side that varies depending on the algorithm for determining the optimal partitioned point, the present embodiment also propose GPU task scheduling for efficient and fair resource distribution when each terminal uses the server's resources.

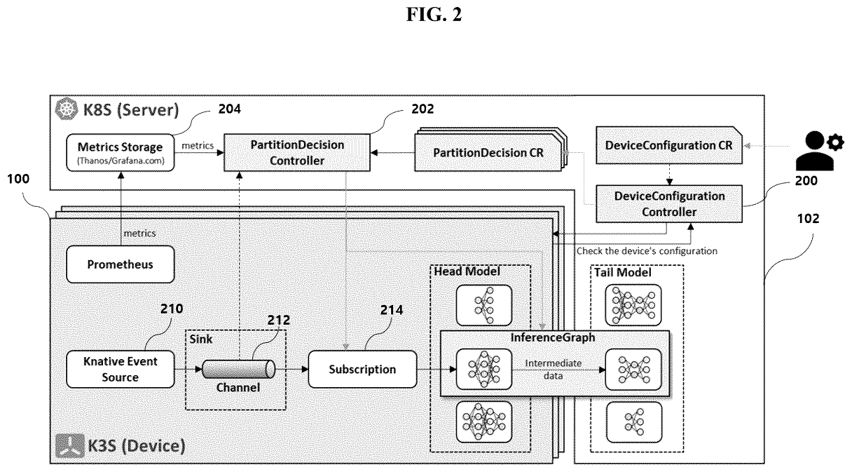

FIG. 2 is a diagram illustrating a detailed configuration of a partitioned computing environment according to the present embodiment.

As illustrated in FIG. 2, the cluster 102 according to the present embodiment may include a first custom controller 200 and a second custom controller 202.

The first custom controller 200 generates a second custom resource corresponding to the plurality of terminals by referencing a first custom resource that defines an optimal partitioned point determination algorithm of a head model executed on a terminal side and a tail model executed on a server side of a deep neural network model to be applied to the plurality of terminals 100.

Then, the second custom controller 202 determines a partitioned point of each of the plurality of terminals by referencing the second custom resource and determines GPU scheduling on the server side for the tail model selected according to the determined partitioned point.

In the present embodiment, the first custom resource is defined as a DeviceConfiguration custom resource, and the second custom resource is defined as a PartitionDecision custom resource. Accordingly, the first custom controller 200 may be defined as a DeviceConfiguration controller, and the second custom controller 202 may be defined as a PartitionDecision controller.

In this way, in order to utilize Kubernetes in a partitioned computing environment, the present embodiment defines DeviceConfiguration custom resource and PartitionDecision custom resource, which are new custom resource definitions that do not exist in the past.

In addition, the custom controllers 200 and 202 that manage each custom resource and perform reconcile logic are proposed together.

The first custom resource according to the present embodiment flexibly defines an optimal partitioned point determination algorithm to be applied to the terminal, that is, an optimal partitioned point determination algorithm of a head model executed on the terminal side of a deep neural network model and a tail model executed on the server side, and defines information on terminals that will use the corresponding algorithm.

The second custom resource defines the ID of each terminal collected from the plurality of terminals 100 connected to the cluster 102, channel information for storing events generated from each terminal, a partitioned point determination algorithm to be used by the terminal, required metrics, or the like.

Here, the resource metric of each terminal may be collected through Prometheus and stored in a metrics storage 204, and the second custom controller 202 may determine the partitioned point of each terminal through the resource metric.

In each terminal, the knative event source 210 may detect an event for inference execution, and the event generated from the knative event source 210 is temporarily stored in the channel 212.

The second custom resource is dependent on the first custom resource, and after the first custom resource is distributed, the second custom resource is distributed by the number of terminals currently connected to the cluster by utilizing the algorithm for determining the optimal partitioned point defined in the first custom resource and the terminal information.

By developing two custom resources so as to be dependent in this way, the life cycles of multiple heterogeneous terminals can be effectively managed, and the partitioned point determination algorithm designated by the operator can be set differently for each terminal, and the partitioned point determination algorithm used can be more easily modified and replaced, thereby improving flexibility.

The second custom controller 202 accesses the plurality of terminals 100, collects information defined in the second custom resource as described above, and performs the role of generating, deleting, and modifying the second custom resource corresponding to each terminal.

According to the present embodiment, the first custom controller 200 monitors the first custom resource defined by the operator and periodically checks whether a new first custom resource is generated, deleted, or modified.

As described above, the second custom controller 202 determines the actual partitioned point in each terminal using the partitioned point determination algorithm defined in the second custom resource, and performs GPU virtualization, allocation, and scheduling for the tail model selected according to the partitioned point.

The second custom controller 202 detects when an event is stored in a channel that temporarily stores events from each terminal and performs reconcile logic for determining a partitioned point.

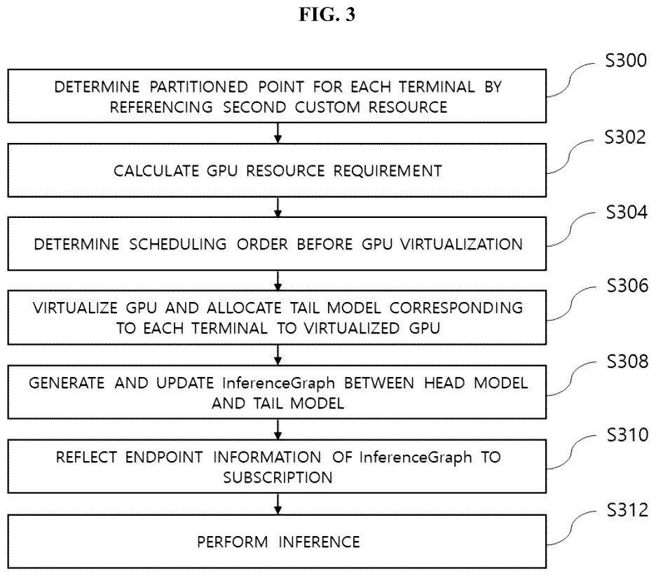

FIG. 3 is a diagram illustrating the execution process of the second custom controller according to the present embodiment.

Referring to FIG. 3, the reconcile logic of the second custom controller 202 first determines a partitioned point using a partitioned point determination algorithm suitable for each terminal by referencing the second custom resource (Step 300).

Step 300 is a process for determining a head model to be executed in each terminal.

Next, the GPU resource requirement for the tail model is calculated by utilizing available resources and server-side GPU information for the partitioned point (Step 302).

Step 302 is a process for calculating the GPU resource requirement for executing the tail model determined according to the partitioned point of each terminal in the cluster.

Then, the GPU resource requirement for the tail model and tail model identification information are utilized before GPU virtualization to determine a scheduling order before GPU virtualization (Step 304).

After Step 304, the GPU is virtualized according to the calculated GPU resource requirement, and the tail model corresponding to each of the plurality of terminals is allocated to the virtualized GPU (Step 306).

When the GPU allocation to the tail model is completed, an InferenceGraph between the terminal-side head model and the server-side tail model is generated and updated (Step 308).

After that, the endpoint information of the corresponding InferenceGraph is reflected in the Subscription 214 that receives the event through the channel 212 and distributed and modified (Step 310).

After Step 310 is completed, the inference using a deep neural network is performed (Step 312).

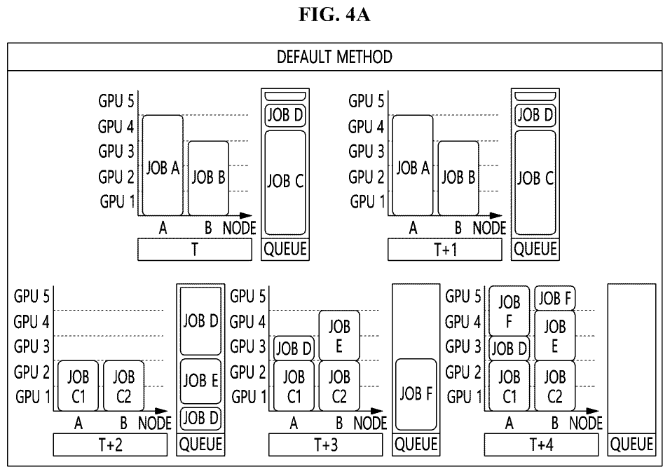

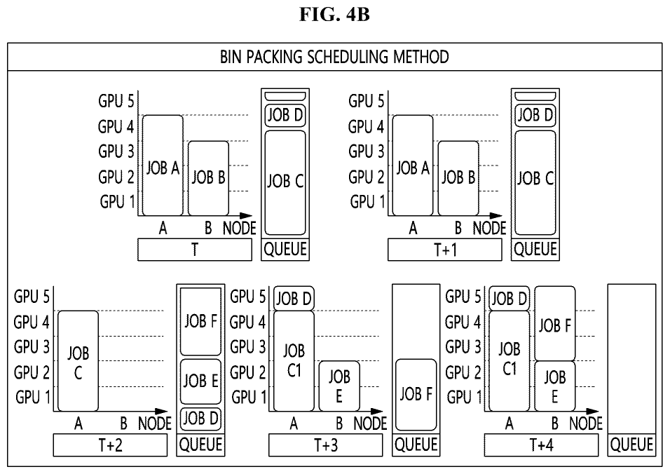

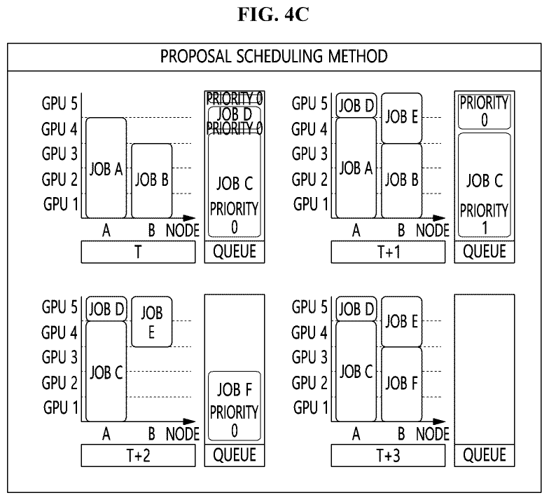

FIGS. 4A to 4C are diagrams illustrating an example of a GPU task scheduling method according to the present embodiment.

As illustrated in FIGS. 4A to 4C, the present embodiment proposes a new scheduling method that can achieve both efficiency and fairness in task scheduling utilizing GPU resources.

The existing Kubernetes scheduling method focuses on efficient distribution based on the current resource status, but it has the problem that this method is not efficient for non-preemptible GPUs.

In the scheduling method according to the present embodiment, when priorities are the same, “bin packing” and “shortest job first (SJF)” methods are used to be combined so that a priority of a task whose order is reversed is adjusted upward when a first in first out (FIFO) principle is violated by the SJF, and when the number of times the order of a given task is reversed exceeds the preset number of times, the task with the lower priority is processed with the highest priority.

This method can provide efficiency and fairness in GPU usage between each terminal. In addition, as the task processing speed increases, the average task waiting time for the tail model decreases, which can lead to a decrease in the overall delay time.

The above-described Kubernetes-based partitioned computing method considering the GPU task scheduling may also be implemented in the form of a storage medium that includes commands that can be executed by a computer, such as an application or program module that is executed by a computer. Computer-readable media can be any available media that can be accessed by a computer, and includes all of volatile and nonvolatile media, and removable and non-removable media. Additionally, computer-readable media can include computer storage media. Computer storage media includes all of volatile and nonvolatile, and removable and non-removable media implemented in any method or technology for storage of information such as computer-readable instructions, data structures, program modules or other data.

The above-described embodiments of the present disclosure have been disclosed for illustrative purposes, and those skilled in the art having ordinary knowledge of the present disclosure will be able to make various modifications, changes, and additions within the spirit and scope of the present disclosure, and such modifications, changes, and additions should be considered to fall within the scope of the following claims.

What is claimed is:

1. A Kubernetes-based partitioned computing apparatus considering GPU task scheduling, the partitioned computing apparatus, comprising:
a first custom controller that generates a second custom resource corresponding to a plurality of terminals by referencing a first custom resource that defines an optimal partitioned point determination algorithm of a head model executed on a terminal side and a tail model executed on a server side of a deep neural network model to be applied to the plurality of terminals; and
a second custom controller that determines a partitioned point of each of the plurality of terminals by referencing the second custom resource, and determines GPU scheduling on the server side for a tail model selected according to the determined partitioned point.

2. The Kubernetes-based partitioned computing apparatus of claim 1, wherein the first custom resource is a DeviceConfiguration custom resource, and
the second custom resource is a PartitionDecision custom resource.

3. The Kubernetes-based partitioned computing apparatus of claim 1, wherein the first custom controller accesses the plurality of terminals and collects at least one of an ID of each terminal, channel information storing an event generated from each terminal, an optimal partitioned point determination algorithm to be used by each terminal, and a resource metric of each terminal to generate the second custom resource.

4. The Kubernetes-based partitioned computing apparatus of claim 3, wherein the second custom resource is dependent on the first custom resource.

5. The Kubernetes-based partitioned computing apparatus of claim 3, wherein the second custom controller calculates a GPU resource requirement for the tail model corresponding to each of the plurality of terminals using an available resource and GPU information according to the partitioned point determined for each of the plurality of terminals, and determines a scheduling order using the calculated GPU resource requirements and tail model identification information before GPU virtualization.

6. The Kubernetes-based partitioned computing apparatus of claim 5, wherein the second custom controller virtualizes a GPU according to the calculated GPU resource requirement and allocates the tail model corresponding to each of the plurality of terminals to the virtualized GPU.

7. The Kubernetes-based partitioned computing apparatus of claim 6, wherein, when priorities are the same, the second custom controller combines bin packing and shortest job first (SJF) methods so that a priority of a task whose order is reversed is adjusted upward when a first in first out (FIFO) principle is violated by the SJF.

8. The Kubernetes-based partitioned computing apparatus of claim 6, wherein the second custom controller generates an InferenceGraph between a terminal-side head model and a server-side tail model when GPU allocation to a tail model corresponding to each of the plurality of terminals is completed.

9. The Kubernetes-based partitioned computing apparatus of claim 8, wherein the second custom controller reflects endpoint information of the InferenceGraph to a Subscription that receives an event from the channel information so that inference is performed.

10. A Kubernetes-based partitioned computing system considering GPU task scheduling, the partitioned computing system comprising:
a plurality of terminals; and
a Kubernetes-based cluster that is connected to the plurality of terminals through a network, generates a second custom resource corresponding to the plurality of terminals by referencing a first custom resource that defines an optimal partitioned point determination algorithm of a head model executed on a terminal side and a tail model executed on a server side of a deep neural network model to be applied to the plurality of terminals, determines a partitioned point of each of the plurality of terminals by referencing the second custom resource, and determines GPU scheduling on the server side for a tail model selected according to the determined partitioned point.

11. A Kubernetes-based partitioned computing method considering GPU task scheduling, the partitioned computing method comprising:
generating a second custom resource corresponding to a plurality of terminals by referencing a first custom resource that defines an optimal partitioned point determination algorithm of a head model executed on a terminal side and a tail model executed on a server side of a deep neural network model to be applied to the plurality of terminals; and
determining a partitioned point of each of the plurality of terminals by referencing the second custom resource and determining GPU scheduling on the server side for a tail model selected according to the determined partitioned point.

12. The Kubernetes-based partitioned computing method of claim 11, wherein the generating includes accessing the plurality of terminals, and collecting at least one of an ID of each terminal, channel information storing an event generated from each terminal, an optimal partitioned point determination algorithm to be used by each terminal, and a resource metric of each terminal to generate the second custom resource.

13. The Kubernetes-based partitioned computing method of claim 12, wherein the determining includes:
calculating a GPU resource requirement for the tail model corresponding to each of the plurality of terminals using an available resource and GPU information according to the partitioned point determined for each of the plurality of terminals, and
determining a scheduling order using the calculated GPU resource requirement and tail model identification information before GPU virtualization.

14. The Kubernetes-based partitioned computing method of claim 13, wherein the determining includes virtualizing a GPU according to the calculated GPU resource requirement and allocating the tail model corresponding to each of the plurality of terminals to the virtualized GPU.

15. The Kubernetes-based partitioned computing method of claim 14, wherein the determining includes generating and updating an InferenceGraph between a terminal-side head model and a server-side tail model when GPU allocation to a tail model corresponding to each of the plurality of terminals is completed.
